(19) United States
(12) Patent Application Publication
(10) Pub. No.: US 2014/0293857 A1
(43) Pub. Date: Oct. 2, 2014

(54) Method and apparatus for managing terminals

(71) Applicants: Lars Dalsgaard, Oulu (FI); Jussi-Pekka Koskinen, Oulu (FI); Ilkka Keskitalo, Oulu (FI); Jarkko Koskela, Oulu (FI); Jani Paavo Johannes Puttonen, Palokka (FI); Dan Forsberg, Helsinki (FI); Timo Rantalainen, Helsinki (FI)

(72) Inventors: Lars Dalsgaard, Oulu (FI); Jussi-Pekka Koskinen, Oulu (FI); Ilkka Keskitalo, Oulu (FI); Jarkko Koskela, Oulu (FI); Jani Paavo Johannes Puttonen, Palokka (FI); Dan Forsberg, Helsinki (FI); Timo Rantalainen, Helsinki (FI)

(73) Assignee: NOKIA CORPORATION, Espoo (FI)

(21) Appl. No.: 14/349,350

(22) PCT Filed: Oct. 7, 2011
(86) PCT No.: PCT/FI2011/050868

§ 371 Date: May 26, 2014

(51) Int. Cl. H04W 52/02

(52) U.S. Cl. CPC H04W 52/0235
USPC 370/311

(57) ABSTRACT

In accordance with an example embodiment of the present invention, there is provided an apparatus comprising at least one memory configured to store an identity of a terminal, at least one processing core configured to use a terminal-specific inactivity timer value and to associate the terminal-specific inactivity timer value with the identity to provide terminal- or user-specific inactivity timers to manage state transitions in mobiles.

### TECHNICAL FIELD

The present application relates generally to managing communication networks.

### BACKGROUND

Wireless communication networks, for example cellular communication networks, may comprise core networks configured to perform central subscriber management and connection switching functions. Such networks may also comprise radio-access networks consisting of at least base stations, the radio-access networks being configured to handle localized functions such as roaming control, handovers and controlling terminal behavior with respect to individual cells.

A radio-access network may be configured to manage access by terminals to the air interface. As a number of terminals may use the same air interface, a sharing scheme may be implemented whereby air interface resources are shared between the terminals. Depending on network design, the air interface may be shared by partitioning it into timeslots, frequency channels or in a code space and by assigning timeslots, channels or spreading codes to individual terminals. Combinations of the foregoing sharing methods are also possible. Timeslots, frequency channels, spreading codes and their combinations may be known, separately or in combination, as air interface resources.

Since terminals don't always need to access the air interface, some networks implement schemes whereby terminals may be assigned more than one state. For example, where a terminal isn't involved in active communication it may be assigned an inactive state, such as for example a low-power sleep mode, which may mean that it doesn't have any active assignment of air interface resources. Alternatively, a terminal in an inactive mode may only be assigned air interface resources sufficient to maintain a signaling connection to the network but not to carry substantial traffic.

Responsive to a determination that a communication connection is needed, a terminal in an inactive state may transition to an active state. For example, where the terminal makes the determination, it may be configured to request air interface resources from the network. Alternatively, for example where the network determines there is an incoming call to the terminal, the network may be configured to page the terminal to cause it to transition to an active state and to assign air interface resources for the incoming call to the terminal.

### SUMMARY

Various aspects of examples of the invention are set out in the claims.

According to a first aspect of the present invention, there is provided an apparatus, comprising at least one memory configured to store an identity of a terminal, at least one processing core configured to derive a terminal-specific inactivity timer value and to associate the terminal-specific inactivity timer value with the identity, and the at least one processing core being further configured to cause the terminal-specific inactivity timer value to be transmitted to the terminal.

According to a second aspect of the present invention, there is provided a method, comprising storing an identity of a terminal, deriving a terminal-specific inactivity timer value and associating the terminal-specific inactivity timer value with the identity, and causing the terminal-specific inactivity timer value to be transmitted to the terminal.

According to a third aspect of the present invention, there is provided an apparatus, comprising at least one processor, at least one memory including computer program code, the at least one memory and the computer program code configured to, with the at least one processor, cause the apparatus to derive a terminal-specific inactivity timer value candidate for the apparatus, and transmit the terminal-specific inactivity timer value candidate to a base station apparatus controlling a cell to which the apparatus is attached.

According to a fourth aspect of the present invention, there is provided a method, comprising deriving a terminal-specific inactivity timer value candidate, and transmitting the terminal-specific inactivity timer value candidate to a base station apparatus controlling a cell.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system where embodiments of the present invention may be employed;

FIG. 2 illustrates an example apparatus 201 capable of supporting embodiments of the present invention;

FIG. 3 is a signaling diagram illustrating functioning of an example system according to one embodiment of the invention;

FIG. 4 is a signaling diagram illustrating functioning of an example system according to one embodiment of the invention; and

FIG. 5 is a signaling diagram illustrating functioning of an example system according to one embodiment of the invention.

### DETAILED DESCRIPTION OF THE DRAWINGS

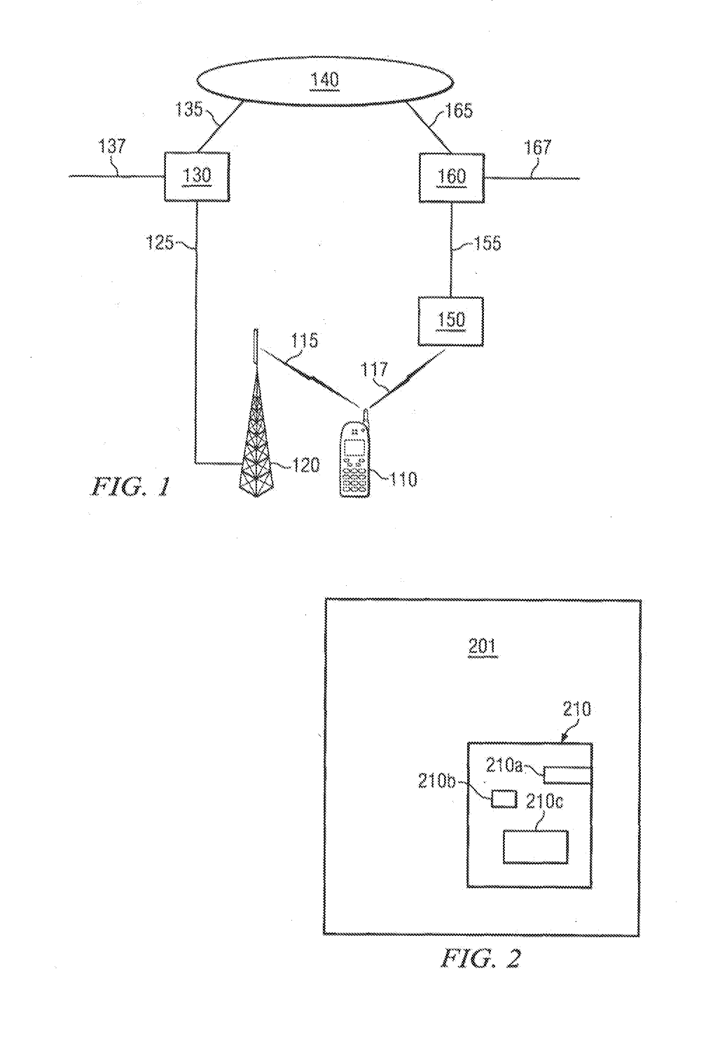

An example embodiment of the present invention and its potential advantages are understood by referring to FIGS. 1 through 5 of the drawings.

FIG. 1 illustrates an example system where embodiments of the present invention may be employed. Mobile apparatus 110, or mobile 110, for example a mobile phone, personal digital assistant, PDA, cellular phone, palmtop computer, laptop or other mobile communications-capable device, is connected to base station 120 by means of wireless link 115. Wireless link 115 may comprise an uplink capable of conveying information from mobile 110 to base station 120 and a downlink capable of conveying information from base station 120 to mobile 110. Wireless link 115 may be in conformance with a cellular technology such as, for example, wideband code division multiple access, WCDMA, global system for mobile communications, GSM or long term evolution, LTE. Mobile 110 may be powered by a battery comprised in mobile 110. Device 110 is herein referred to as a mobile, but it is to be understood that the scope of the description encompasses also embodiments where the device is not mobile.

Base station 120 may be capable of communicating in accordance with at least one, and in some embodiments more than one, cellular technology such as, for example, those mentioned above. Base station 120 may be powered from a stable power source and may be furnished with a backup battery. Base station 120 may be connected to a core network node 130 by means of connection 125. Connection 125 may be a wire-line connection or, for example, a directional microwave link. Core network node 130 may act as a gateway toward further nodes and may be configured to perform functions relating to controlling a cellular communications network. Examples of such functions include routing, authentication, access control and billing subscribers. Examples of core network nodes include switches, management nodes, serving gateways, support nodes and charging systems. Core network node 130 may connect to further core network nodes, which are not illustrated, by means of connection 137. Core network node 130 may connect to the internet 140 by means of connection 135. In some embodiments core network node 130 connects to the internet via connection 137 instead of connection 135.

In some embodiments core network node 130 may be absent, in which case base station 120 may be connected directly to other base stations and, optionally, the internet 140. In such cases base station 120 may be furnished with at least some of the core network functions mentioned above. In some embodiments nodes not illustrated in FIG. 1 may be present, for example a base station controller node may be disposed between base station 120 and core network node 130.

In some embodiments, in addition to or instead of the cellular chain comprising base station 120 and core network node 130 mobile 110 may communicate by means of a non-cellular chain comprising access point 150 and gateway 160. Mobile 110 may communicate with access point 150 via link 117 which may operate according to wireless local area network, WLAN, technology or worldwide interoperability for microwave access, WiMAX, technology, for example. Link 117 may, like wireless link 115, comprise an uplink and a downlink. Access point 150 may be connected to gateway 160 by means of connection 155. Connection 155 may be a wire-line connection such as an Ethernet or digital subscriber line, DSL, connection. Gateway 160 may be capable to communicate with internet 140 by means of connection 165 and by further gateways by means of connection 167, which may both be wire-line connections or wireless connections. In some embodiments gateway 160 is absent and access point 150 is directly connected to internet 140.

Responsive to a user of a mobile 110 requesting information from a network, such as internet 140, mobile 110 may be configured determine whether it has a connection already, or whether it is in an idle state without a connection. Responsive to a determination that mobile 110 is in idle state without a connection, mobile 110 may be configured to initiate connectivity to internet 140 via the cellular or non-cellular route. The initiating may comprise, for example, establishing a radio bearer to base station 120 or access point 150, resolving an address using a doman name system, DNS, server, and establishing a protocol connection to a node comprised in the network.

In the example of a LTE system, mobile 110 may be in a detached, idle or active state. The detached state may correspond to a state where mobile 110 is switched on and mobile 110 is in the process of searching for a network, authenticating with the network and registering its presence in the network. The active state may correspond to a state where mobile 110 is registered in the network and where it has a radio resource control, RRC, connection with base station 120. When mobile 110 is in the active state, the cellular network may be capable of transmitting information to mobile 110 due to an assignment of air interface resources being present. The idle state may correspond to a low-power state where no RRC connection is active between mobile 110 and base station 120. In some embodiments, base station 120 doesn't store context information relating to mobiles in idle state.

Context information may comprise history information on cells mobile 110 has been attached to previously, possibly including cells from more than one network and radio access technology. The context information may alternatively or further comprise at least some of information on active radio bearers, capability information of mobile 110, and a radio resource configuration of mobile 110, for example. Context information may comprise, for example, parameters of internet protocol, IP, bearer services and/or network internal routing information such as flow templates and quality-of-service parameters.

In some embodiments, core network node 130 has less accurate knowledge of the locations of mobiles 110 in idle state. For example, core network node 130 may know which cell each mobile 110 in active state is attached to but only tracking areas, TA, where mobiles 110 in idle state can be reached. Tracking areas may comprise more than one cell. In other words, the core network may know the locations of active state mobiles with the granularity of a cell, and the core network may know the locations of idle state mobiles with the granularity of a tracking area.

In some embodiments, idle-state mobiles 110 are not configured to inform the network of every cell change, or handover. When the network determines that an incoming call to an idle-state mobile 110 needs to be completed, the network may be configured to page all cells comprised in the tracking area where mobile 110 is located. A process whereby a mobile informs the network of a change in tracking area is known as a tracking area update. In some networks, a mobile 110 may be associated with more than one tracking area at a time.

Mobile 110 may undergo mobility procedures with the cellular chain independently of any mobility procedures associated with the non-cellular chain. Also, mobile 110 may be in an active or idle state with respect to the cellular chain independently of any states it may be in with respect to the non-cellular chain. The non-cellular chain may also have procedures to manage transitions of mobile 110 between states, such as idle or active states.

When mobile 110 is in the active state with respect to the cellular chain, the cellular system and mobile 110 may monitor the level of activity of mobile 110 with respect to base station 120. In detail, the network may keep a timer to gauge for how long mobile 110 has been in the active state without transmitting or receiving data over the RRC connection allocated in connection with the active state. Since the amount or air interface resources is limited, it is useful to keep only those mobiles in an active state, that are actually involved in current communication. Mobiles not currently in communication may be kept in an idle state to conserve air interface resources.

A timer used to manage mobiles with respect to active and idle states may be referred to as an inactivity timer or release timer, for example. Hereinafter such a timer will be referred to as an inactivity timer. Expiry of the inactivity timer may trigger the network to transmit a signal to mobile 110 associated with the timer, the signal instructing the mobile to transition to the idle state. In some embodiments, each time a mobile 110 transmits data, the network resets the inactivity timer of that mobile to the inactivity timer value, and after the transmission, the inactivity timer will start to elapse from the inactivity timer value toward zero. Alternatively, the network resets the timer to zero and the inactivity timer will start to elapse from zero toward the inactivity timer value. In other words, the inactivity timer value is the space of time a mobile 110 may remain in an active state before being transitioned to an idle state. Obviously, whether the timer goes from the inactivity timer value toward zero, or starts from zero and proceeds toward the inactivity timer value has no effect on the functioning of the system: what the system responds to is expiry of the time interval defined by the inactivity timer value since the previous transmission.

In some embodiments of the invention, the inactivity timer value is set on a mobile-by-mobile basis meaning that different mobiles have different inactivity timer values. This is useful since mobiles have different users with different needs. For example, a mobile unit that monitors an electricity meter may only report the value of the meter once per week, being otherwise idle. Such a mobile, which may be referred to as a mobile only since the device is analogous to mobiles as it may be fixed in place and not strictly mobile, may be associated with a very short or very long inactivity timer value. After reporting the meter value, the mobile may transition to idle state essentially at once since it is known there will be no follow-up communication for a week, for example.

More generally, the optimal value for the inactivity timer value may depend at least in part on which applications are active in each mobile 110. Different applications have different traffic statistics, meaning that a different inactivity timer value is optimal. For example, a text-based chat application may be expected to produce traffic every 10-20 seconds or so, so an inactivity timer value of at least 30 seconds might be useful to prevent unnecessary switching between states between traffic instances. As another example, a streaming audio feed may benefit most from an inactivity timer value of only 5 seconds, since it may be expected that once the feed is disconnected the listening session is over. Should mobile 110 have several active applications, the longest inactivity timer value from among the inactivity timer values associated with the active applications may be optimal for use in the situation, to avoid unnecessary back-and-forth transitions between active and idle statuses.

Since mobile 110 knows the application or applications running on it, and possibly also the characteristics of traffic associated with the application or applications, it is in a good position to suggest to the network a value to be used as the inactivity timer value. Mobile 110 may be configured to transmit a suggested inactivity timer value to the network in connection with at least one of a handover, an initial registration and state transition from idle to connected mode , or responsive to determining that the set of active applications changes, for example. As an example, mobile 110 may transmit a first suggested inactivity timer value to the network, and later responsive to a change in the setoff active applications send a second, updated suggested inactivity timer value. The suggested inactivity timer value may be derived by mobile 110 from the set of active applications, or from characteristics of traffic to and/or from mobile 110. Also latency requirements of active applications can affect the optimal inactivity timer value. More stringent latency requirements could favour keeping the mobile in active state longer, since the latency associated with transitioning from active to idle and idle to active state can then in some instances be avoided. In one example being configured to transmit also covers a network request, with mobile 110 responsively transmitting a suggested inactivity timer value and/or traffic characteristics to the network.

Responsive to receiving the suggested inactivity timer value, a node comprised in the network, such as in the cellular chain illustrated in FIG. 1, may be configured to derive an inactivity timer value to be used. If the suggested inactivity timer value is within a range of allowable or network acceptable inactivity timer values as defined in the network, the network may choose to use the suggested inactivity timer value and indicate this to mobile 110 in a signaling message. Should the suggested inactivity timer value be outside the range of allowable inactivity timer values, or otherwise not acceptable to network, the network may select the allowable inactivity timer value that is closest to the suggested one or some other value. For example, if the suggested inactivity timer value is 10 minutes and the network allows values between 5 seconds and 5 minutes, the network may select an inactivity timer value of 5 minutes.

Alternatively to a suggested inactivity timer value, mobile 110 may be configured to indicate to the network information of its data profile, for example the amount and periodicity of data transmissions, and/or associated latency requirements. The network may use the indicated information when deriving an inactivity timer value for this mobile.

In addition to information provided by the mobile, the network may use information available to it when deriving the mobile-specific inactivity timer value. For example, the base station may use knowledge of the fact that the mobile has been attached to the base station for a long time to set a longer inactivity timer value since the mobile appears to not be moving very much. The base station may make use of knowledge it may have of at least one of the cell size, the cell load and the cell type. In some embodiments a larger cell size would favour a longer inactivity timer value. In some embodiments a higher cell load would favour a shorter inactivity timer value. In some embodiments a cell type specializing in serving a restricted subscriber set, or small cells in general, may favour a longer inactivity timer value. The network may also derive estimates of how fast the mobiles are moving, for example from Doppler shift measurements or from adaptive channel estimation or from a frequency of cell changes. A faster moving mobile may benefit most from a shorter inactivity timer value in order to reduce mobility-related signaling. The network may also be aware of quality requirements relating to the RRC connection or another connection serving the mobile. Such information may also be used when deriving the inactivity timer value. The choice of inactivity timer value is a trade-off between multiple level parameters such as an amount of mobility related signaling, idle to active state transition signaling, mobile power consumption, user experience in form of QoS, jitter, delay and practical applicability, for example. Examples of practical applicability include requirements from active applications in mobile 110.

In some embodiments, where mobile 110 transmits a suggested inactivity timer value to the network and doesn't receive a response within a predetermined time, mobile 110 is configured to take the suggested inactivity timer value into use. In such a case, mobile 110 is configured to transition to idle mode responsive to expiry of the suggested inactivity timer value without receiving a signaling instruction from the network.

According to an embodiment of the invention, an apparatus such as, for example, base station 120 is configured to store an identity of a terminal. The identity may be an international mobile equipment identity, IMEI, or an identity of a user of the terminal such as an international mobile subscriber identity, IMSI, for example. The identity may be stored in a memory comprised in the apparatus. The identity may be fetched from a core network node and/or obtained in connection with admitting the terminal to a cell controlled by the apparatus, for example. The apparatus of this embodiment comprises at least one processing core, for example comprised in at least one processor comprised in the apparatus. The at least one processing core is configured to derive a terminal-specific inactivity timer value and to associate the terminal-specific inactivity timer value with the identity, for example by defining a mapping between the terminal-specific inactivity timer value and the identity. The at least one processing core is further configured to cause the terminal-specific inactivity timer value to be transmitted to the terminal.

The terminal-specific inactivity timer value may determine when to transition the terminal from an active state into an idle state, wherein the terminal transitions into the idle state responsive to no information being communicated between the terminal and the apparatus for a time that corresponds to the terminal-specific inactivity timer value.

The terminal may make the transition on its own responsive to a determination that the timer expires with no transmissions, or the terminal may alternatively receive a signaling message from the network instructing it to transition to the idle state, where the network transmits the signal responsive to the timer expiring at a network node. Autonomous transition to idle state could alternatively be configurable by the network. In one embodiment the terminal may use a suggested inactivity timer value, such that mobile 110 may use the suggested inactivity timer value for autonomous release of connection. As one non-limiting example, mobile 110 may provide the network with a proposal for a terminal specific inactivity timer which the mobile, despite missing feedback from network, will use as indication of when the mobile will release the connection.

In embodiments where the terminal observes the timer and transitions to idle state responsive to the expiry of the timer without receiving a signal from the network instructing the terminal to transition to idle state, the network may be configured to observe expiry of the same timer and begin considering the terminal as being in an idle state responsive to expiry of the timer, without signaling exchanges between the network and the terminal. Additionally, the network, when knowing the inactivity timer value the mobile is intending to use, may instruct the mobile to use another value if, for example, for some network specific reason another value would be more optimal.

In some embodiments, the apparatus, such as base station 120, is configured to receive from the terminal a suggested terminal-specific inactivity timer value. In these embodiments, the at least one processing core is configured to derive the terminal-specific inactivity timer value based at least in part on the suggested value. For example, the at least one processing core may derive the terminal-specific inactivity timer value based on the suggested value and network policies governing which inactivity timer values are allowable. Where the apparatus receives an updated suggested terminal-specific inactivity timer value, the at least one processing core may be configured to re-derive the terminal-specific inactivity timer value and take the new value into use.

As another example, the at least one processing core may be configured to use other information stored in the apparatus than network policies. Information that may be used includes at least one of: historical averages of inactivity timer values in a cell controlled by the apparatus, quality characteristics of a bearer serving the terminal, a terminal category of the terminal, and information received from a core network. In cells where a historical average of terminal-specific inactivity timer values is low, the at least one processing core may be configured to favour a lower value when deriving the terminal-specific inactivity timer value. This may be because, for example, the cell is situated next to a busy road where mobiles move fast in cars, making long-term attachment to the cell with an active connection unlikely. A low-quality bearer may cause the at least one processing core to favour a shorter value when deriving the terminal-specific inactivity timer value. This may be because a low-quality bearer may not suffer from the latency of re-establishing the active state. On the other hand, should the mobile be associated with a bearer with a high quality requirement, the at least one processing core may favour a longer value when deriving the terminal-specific inactivity timer value since a high-quality bearer may not tolerate the latency from re-establishing the active state very well.

A further example of information stored in the apparatus is a terminal category. Where the terminal category indicates the terminal is a machine-to-machine terminal, for example, the appropriate terminal-specific inactivity timer value may be short since the terminal is likely to only experience isolated bursts of communication. Alternatively it may be kept very long, even infinite, in order to reduce state transition signaling. On the other hand, should the terminal category indicate a multimedia terminal, the appropriate terminal-specific inactivity timer value may be longer since the terminal may experience continual intermittent connectivity. Information received from a core network may comprise, for example, information indicating that the subscriber using the terminal is a premium user. A premium user may be given a longer terminal-specific inactivity timer value so as to provide for the user a faster user experience by avoiding some latency-incurring transitions from idle state to active state. Since the information that the subscriber is a premium user is received from the core network and not the user's own terminal, the information may be considered in the network to be reliable. Information on subscriber class, such as premium/non-premium, may be stored in the core network in a subscriber database, for example.

In embodiments where the apparatus is a base station, the base station may be configured to transmit the derived terminal-specific inactivity timer value to a target base station when the terminal, such as mobile 110, undergoes handover to a cell not controlled by the base station, such as base station 120. The derived inactivity timer value may be transmitted in a handover signaling message, for example. In some embodiments, the apparatus is configured to receive assistance information from a mobile for deriving a terminal-specific inactivity timer value for the mobile. The assistance information may be received responsive to a request from the apparatus or it may alternatively be received unsolicited. The assistance information may comprise, for example, information on applications or application types active in the mobile, mobility characteristics of the mobile, a terminal category of the apparatus and a cell type of a cell the apparatus is attached to. Where the apparatus receives assistance information, the apparatus may be configured to use it when deriving a terminal-specific inactivity timer value. Where the apparatus received assistance information, it may or may not, depending on the embodiment, also receive a suggested inactivity timer value.

According to some embodiments of the invention a second apparatus, such as mobile 110, is configured to derive a terminal-specific inactivity timer value candidate and transmit the inactivity timer value candidate to a base station apparatus. The inactivity timer value candidate may be considered to be a suggested value for the terminal-specific inactivity timer value.

The second apparatus, such as mobile 110, may be configured to derive the terminal-specific inactivity timer value candidate based at least in part on at least one of: applications or application types active in the second apparatus, mobility characteristics of the apparatus, a terminal category of the apparatus and a cell type of a cell the apparatus is attached to. An example of a terminal category is a machine-type terminal. In some embodiments, the second apparatus is configured to derive an updated terminal-specific inactivity timer value candidate and transmit it to the network responsive to detecting a change in the applications or application types active in the second apparatus.

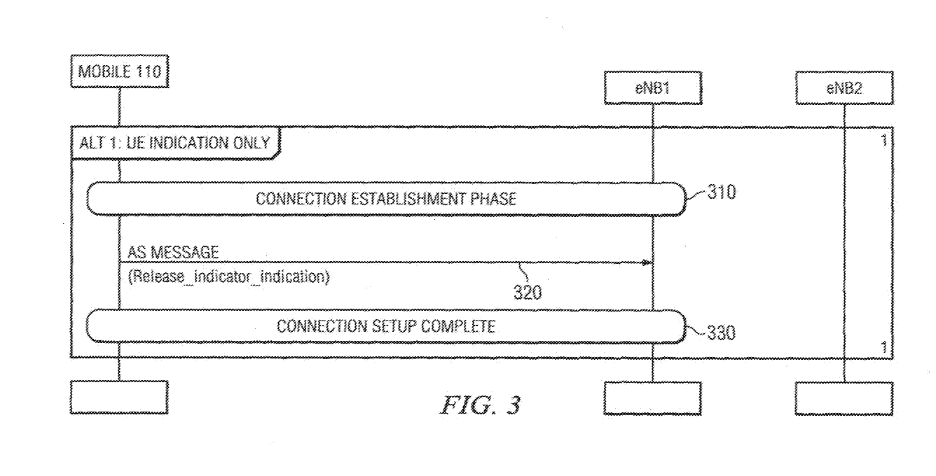

FIG. 3 is a signaling diagram illustrating functioning of an example system according to one embodiment of the invention. Network elements are illustrated vertically. The first network element from the left is mobile 110, followed by two base stations such as base station 120, which in this illustration are labeled eNB after the naming convention of the LTE system. In phase 310, a connection is established between mobile 110 and the base station. In phase 320, mobile 110 transmits to the base station the terminal-specific inactivity timer value candidate. The base station may be configured to consider the candidate when deriving a terminal-specific inactivity timer value for mobile 110. The message of phase 320 is illustrated as an access stratum, AS, message in FIG. 3, however the invention isn't limited to this example. Phase 330 denotes that connection setup is complete, in other words in the illustrated embodiment the candidate is transmitted during, and in connection with, connection establishment and setup. In the illustrated embodiment, the base station doesn't transmit a specific message back to mobile 110 informing of the derived terminal-specific inactivity timer value. The base station may control the state of mobile 110 by transmitting signals to mobile 110 when the base station decides that the state of mobile 110 is to be changed.

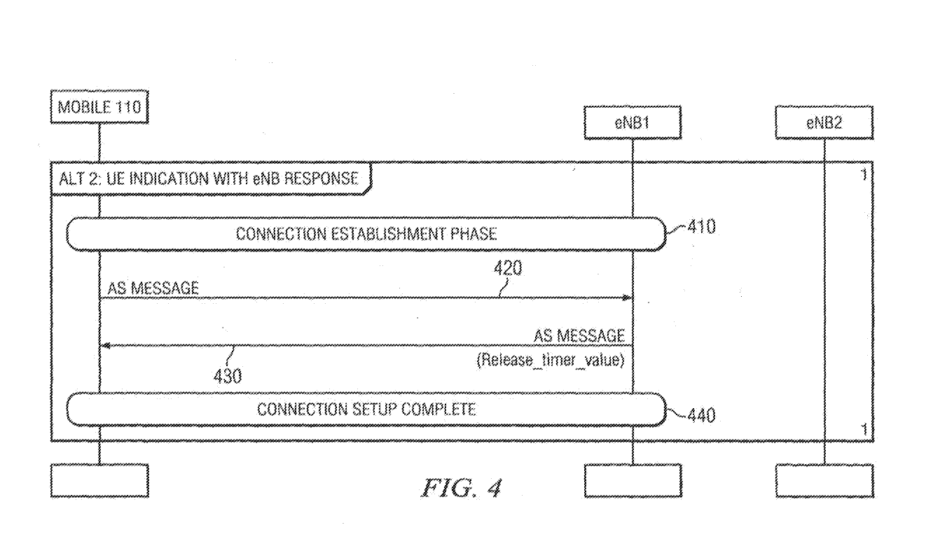

FIG. 4 is a signaling diagram illustrating functioning of an example system according to one embodiment of the invention. Network elements are illustrated vertically. The first network element from the left is mobile 110, followed by two base stations such as base station 120, which in this illustration are labeled eNB after the naming convention of the LTE system. In phase 410, a connection is established between mobile 110 and the base station. In phase 420, mobile 110 transmits to the base station the terminal-specific inactivity timer value candidate. The base station may be configured to consider the candidate when deriving a terminal-specific inactivity timer value for mobile 110. In this embodiment, the base station replies to mobile 110 with a signaling message 430, informing mobile 110 of the derived terminal-specific inactivity timer value. A benefit of message 430 is that mobile 110 becomes capable of transitioning to the idle state even without a specific signal from the base station instructing it to do so. In phase 440, the connection setup phase is complete. It should be noted, that the derived terminal-specific inactivity timer value signaled in phase 430 isn't necessarily the same value as the terminal-specific inactivity timer value candidate transmitted by mobile 110 in phase 420. The messages of phases 420 and 430 are illustrated as access stratum, AS, messages in FIG. 4, however the invention isn't limited to this example.

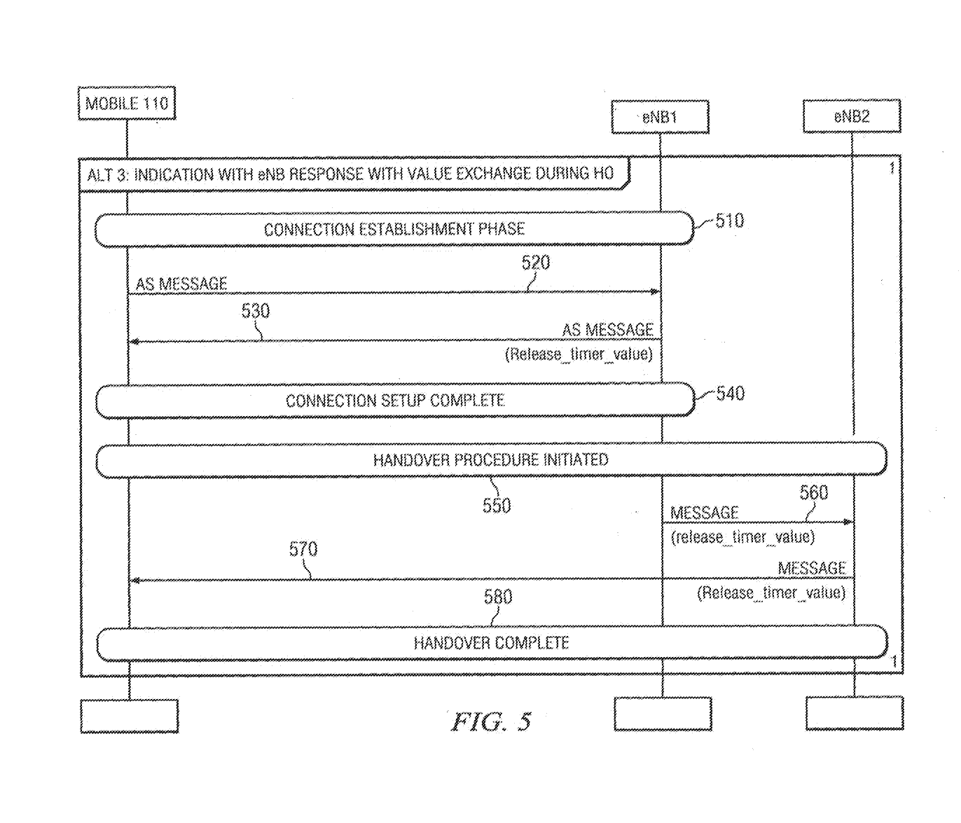

FIG. 5 is a signaling diagram illustrating functioning of an example system according to one embodiment of the invention. As in FIG. 4, network elements are illustrated vertically. The first network element from the left is mobile 110, followed by two base stations such as base station 120, which in this illustration are labeled eNB after the naming convention of the LTE system. Phases 510, 520, 530 and 540 correspond substantially to phases 410, 420, 430 and 440 in FIG. 4, respectively. In phase 550 it is determined that mobile 110 is to be handed over to a cell controlled by a second base station, eNB2. The determination may be made, for example, in base station eNB 1 based on measurement data received from mobile 110. In phase 560 base station eNB1 transmits the derived terminal-specific inactivity timer value relating to mobile 110 to the second base station eNB2, which is in terms of the handover the target base station. The second base station eNB2 may be configured to use the inactivity timer value it receives in phase 560 as a suggested inactivity timer value, and derive a new inactivity timer value for mobile 110 to use in the new cell. In phase 570, which is optional, base station eNB2 may inform mobile 110 of the new terminal-specific inactivity timer value. It should be noted, that the new terminal-specific inactivity timer value may be the same value, or a different value, as the terminal-specific inactivity timer value signaled in phase 560. The messages of phases 520 and 530 are illustrated as access stratum, AS, messages in FIG. 5, however the invention isn't limited to this example.

FIG. 2 illustrates an example apparatus 201 capable of supporting embodiments of the present invention. The apparatus may correspond to mobile 110, or base station 120, for example. The apparatus is a physically tangible object, for example a mobile telephone, personal digital assistant, data dongle or a similar device. The apparatus may comprise a control apparatus 210, for example a digital signal processor, DSP, processor, field-programmable gate array, FPGA, application-specific integrated circuit, ASIC, chipset or controller. The apparatus may further comprise a transmitter and/or a receiver 210a configured to enable the apparatus 201 to connect to other apparatuses. A combination of transmitter and receiver may be called a transceiver. The apparatus may comprise memory 210b configured to store information, for example a terminal-specific inactivity timer value. The memory may be solid-state memory, dynamic random access memory, DRAM, magnetic, holographic or other kind of memory. The apparatus may comprise logic circuitry 210c configured to access the memory 210b and control the transmitter and/or a receiver 210a. The logic circuitry 210c may be implemented as software, hardware or a combination of software and hardware. The logic circuitry may comprise a processing core. The logic circuitry 210c may execute program code stored in memory 210b to control the functioning of the apparatus 201 and cause it to perform functions related to embodiments of the invention. The logic circuitry 210c may be configured to initiate functions in the apparatus 201, for example the sending of data units via the transmitter and/or a receiver 210a. The logic circuitry 210c may be control circuitry. The transmitter and/or a receiver 210a, memory 210b and/or logic circuitry 210c may comprise hardware and/or software elements comprised in the control apparatus 210.

Memory 210b may be comprised in the control apparatus 210, be external to it or be both external and internal to the control apparatus 210 such that the memory is split to an external part and an internal part. If the apparatus 201 does not comprise a control apparatus 210 the transmitter and/or a receiver 210a, memory 210b and logic circuitry 210c may be comprised in the apparatus as hardware elements such as integrated circuits or other electronic components. The same applies if the apparatus 201 does comprise a control apparatus 210 but some, or all, of the transmitter and/or a receiver 210a, memory 210b and logic circuitry 210c are not comprised in the control apparatus 210. In embodiments where apparatus 201 is a mobile user equipment, apparatus 201 may comprise at least one antenna

Without in any way limiting the scope, interpretation, or application of the claims appearing below, a technical effect of one or more of the example embodiments disclosed herein is that an optimal inactivity timer value can be selected for each terminal. Another technical effect of one or more of the example embodiments disclosed herein is that air interface resources are managed more efficiently. Another technical effect of one or more of the example embodiments disclosed herein is that a better user experience can be provided to premium users.

Embodiments of the present invention may be implemented in software, hardware, application logic or a combination of software, hardware and application logic. The software, application logic and/or hardware may reside on memory 210b, the control apparatus 210 or electronic components, for example. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable non-transitory storage medium that may be any media or means that can contain or store the instructions for use by or in connection with an instruction execution system, apparatus, or device, such as a computer. The scope of the invention comprises computer programs configured to cause methods according to embodiments of the invention to be performed.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one memory configured to store an identity of a terminal;
at least one processing core configured to derive a terminal-specific inactivity timer value and to associate the terminal-specific inactivity timer value with the identity; and
the at least one processing core being further configured to cause the terminal-specific inactivity timer value to be transmitted to the terminal, wherein the apparatus comprises a base station.

2. An apparatus according to claim 1, wherein the inactivity timer determines when to transition the terminal from an active state into an idle state, wherein the terminal transitions into the idle state responsive to no information being communicated between the terminal and the apparatus for a time that corresponds to the terminal-specific inactivity timer value.

3. An apparatus according to claim 1, wherein the at least one processing core is further configured to cause an instruction to be transmitted to the terminal responsive to expiry of the inactivity timer, wherein the instruction instructs the terminal to transition to the idle state.

4. An apparatus according to claim 1, wherein the at least one processing core is further configured to consider the terminal as in idle state responsive to expiry of the inactivity timer without transmitting an instruction to the terminal

5. An apparatus according to claim 1, wherein the apparatus is configured to receive a suggested value for the terminal-specific inactivity timer value from the terminal, and wherein at least one processing core is configured to derive the terminal-specific inactivity timer value is at least in part based on the suggested value.

6. An apparatus according to claim 5, wherein the apparatus is configured to derive the terminal-specific inactivity timer value based on the suggested value and information stored in the apparatus.

7. An apparatus according to claim 6, wherein the information stored in the apparatus comprises at least one of: a historical average of inactivity timer values in a cell controlled by the apparatus, a quality characteristic of a bearer serving the terminal, a terminal category of the terminal, and information received from a core network.

8. An apparatus according to claim 1, wherein the apparatus is configured to transmit the terminal-specific inactivity timer value to a target base station apparatus in connection with a handover of the terminal to the target base station apparatus.

9. A method, comprising:
storing, in a base station, an identity of a terminal;
deriving, in the base station, a terminal-specific inactivity timer value and associating the terminal-specific inactivity timer value with the identity; and
causing the terminal-specific inactivity timer value to be transmitted to the terminal from the base station.

10. A method according claim 9, further comprising receiving a suggested value for the terminal-specific inactivity timer value from the terminal, and deriving the terminal-specific inactivity timer value is at least in part based on the suggested value.

11. A method according to claim 10, comprising deriving the terminal-specific inactivity timer value based at least in part on the suggested value and stored information.

12. A method according to claim 11, wherein the stored information comprises at least one of: a historical average of inactivity timer values in a cell controlled by an apparatus, a quality characteristic of a bearer serving the terminal, a terminal category of the terminal, and information received from a core network.

13. An apparatus, comprising:
at least one processor; and
at least one memory including computer program code, wherein
the at least one memory and the computer program code configured to, with the at least one processor, cause the apparatus to perform at least the following:
derive a terminal-specific inactivity timer value candidate for the apparatus, and
transmit the terminal-specific inactivity timer value candidate to a base station apparatus controlling a cell to which the apparatus is attached.

14. An apparatus according to claim 12, wherein the terminal-specific inactivity timer value candidate is derived at least in part depending on at least one of:
applications active in the apparatus, application types of applications active in the apparatus, mobility characteristics of the apparatus, a terminal type of the apparatus and cell type of a cell the apparatus is attached to.

15. An apparatus according to claim 13, wherein the apparatus is configured to derive an updated terminal-specific inactivity timer value candidate responsive to a change in input information used in the derivation, and to transmit the updated candidate to the base station apparatus.

16. An apparatus according to claim 13, wherein the apparatus is configured to transmit toward a network information concerning at least one of: applications active in the apparatus, application types of applications active in the apparatus, mobility characteristics of the apparatus, a terminal type of the apparatus and cell type of a cell the apparatus is attached to.

17. A method, comprising:
deriving a terminal-specific inactivity timer value candidate, and
transmitting the terminal-specific inactivity timer value candidate to a base station apparatus controlling a cell.

18. (canceled)

19. (canceled)
